(19) United States
(12) Patent Application Publication
(10) Pub. No.: US 2007/0284864 A1
(43) Pub. Date: Dec. 13, 2007

(54) Inflatable vehicle occupant protection device construction

(75) Inventors: Gabriel Anaya, Shelby Township, MI (US); Alberto Rodriguez, Rochester Hills, MI (US); Jorge E. Holguin, Chihuahua (MX)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 11/449,327

(22) Filed: Jun. 8, 2006

(51) Int. Cl. B60R 21/231

(52) U.S. Cl. 280/743.1; 280/743.2; 280/740

(57) ABSTRACT

An inflatable vehicle occupant protection device (14) includes a single sheet of material (50) comprising a front panel (40) and a rear panel (42), each having a substantially circular configuration. The sheet (50) has a central portion (52) where peripheral portions of the front and rear panels (40 and 42) merge with each other. The sheet (50) is folded along the central portion (52) to position the front and rear panels (40 and 42) overlying each other. A perimeter connection (110) connects the front and rear panels (40 and 42) along the periphery of the front and rear panels.

### FIELD OF THE INVENTION

The present invention relates to an inflatable vehicle occupant protection device for helping to protect an occupant of a vehicle.

### BACKGROUND OF THE INVENTION

It is known to inflate an inflatable vehicle occupant protection device to help protect a vehicle occupant in the event of a vehicle collision. Examples of inflatable vehicle occupant protection devices include driver and passenger air bags, side air bags, inflatable curtains, inflatable seat belts, inflatable knee bolsters, and inflatable head liners.

Inflatable vehicle occupant protection devices may have a variety of constructions. For example, an inflatable vehicle occupant protection device may be constructed of overlying woven panels that are interconnected by means, such as stitching or ultrasonic welding, to form connections or seams that help define an inflatable volume of the protection device. As another example, an inflatable vehicle occupant protection device may have a one piece woven construction in which overlying panels are woven simultaneously. At selected locations adjacent the panels, the one piece woven construction forms single layer connections or seams that help define an inflatable volume of the one piece woven protection device.

### SUMMARY OF THE INVENTION

The present invention relates to an inflatable vehicle occupant protection device that includes a single sheet of material comprising a front panel and a rear panel. Each of the front and rear panels has a substantially circular configuration. The sheet has a central portion where peripheral portions of the front and rear panels merge with each other. The sheet is folded along the central portion to position the front and rear panels overlying each other. A perimeter connection connects the front and rear panels along the periphery of the front and rear panels.

The present invention also relates to an inflatable vehicle occupant protection device including a single sheet of material comprising a front panel and a rear panel. A long tether interconnects the front and rear panels. First and second short tethers interconnect the front and rear panels. The sheet is folded over to position the front and rear panels overlying each other. A first connection connects a first end of the long tether and a first end of the first short tether to the rear panel. A second connection connects a second end of the long tether and a first end of the second short tether to the front panel. A third connection connects second ends of the first and second short tethers. A perimeter connection connects the front and rear panels along a periphery of the front and rear panels to form an inflatable volume of the inflatable vehicle occupant protection device.

The present invention further relates to an inflatable vehicle occupant protection device including a sheet of material comprising a front panel and a rear panel. The sheet is one of a plurality of sheets cut from a bulk sheet of material in a nested pattern. The protection device also includes at least one of a heat shield panel and a reinforcing panel that is cut from a portion of the bulk sheet of material left over from the nested pattern of sheets.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic view of an inflatable vehicle occupant protection device, according to the present invention;

FIG. 2 is an exploded perspective view of a portion of the protection device prior to assembly;

FIG. 3 is a plan view illustrating the assembly of the protection device;

FIG. 4 is a sectional view taken generally along line 4-4 in FIG. 3;

FIG. 5 is a sectional view taken generally along line 5-5 in FIG. 3;

FIGS. 6 and 7 are plan views illustrating the protection device at different stages of assembly;

FIG. 8 is a sectional view illustrating the protection device in an assembled condition; and

FIG. 9 is a plan view illustrating the manufacture of a portion of the protection device, according to the present invention.

### DETAILED DESCRIPTION OF THE INVENTION

An apparatus 10 helps to protect an occupant of a vehicle 12. The apparatus 10 includes an inflatable vehicle occupant protection device in the form of an inflatable air bag 14. In the embodiment illustrated in FIG. 1, the air bag 14 is a driver air bag for helping to protect an occupant of a driver side 20 of the vehicle 12. The apparatus 10 may include a similar or identical air bag on a passenger side (not shown) of the vehicle 12. Those skilled in the art will appreciate that the construction of the air bag 14 disclosed herein may be applied to other inflatable vehicle occupant protection devices, such as inflatable curtains, side impact air bags, inflatable seat belts, inflatable knee bolsters, and inflatable head liners.

In the embodiment illustrated in FIG. 1, the air bag 14 is mounted to a steering wheel 32 of the vehicle 12. The air bag 14 could, however, be mounted in an alternative location. For example, a passenger air bag (not shown) may be mounted in a dash or instrument panel 34 of the vehicle 12. An inflator 36 is connected in fluid communication with the air bag 14. The air bag 14 is inflatable from a deflated and stored condition illustrated in dashed lines at 14′ in FIG. 1 to the inflated and deployed condition illustrated in solid lines at 14 in FIG. 1.

The air bag 14 includes front and rear panels 40 and 42, respectively, that are arranged in an overlying manner and interconnected to help define an inflatable volume 44 of the air bag 14. As shown in the embodiment of FIG. 1, the air bag 14 may also include one or more tethers 46 for helping to limit movement of the front panel 40 away from the rear panel 42 and the steering wheel 32 when the air bag is deployed.

The inflator 36 may have a known construction that is suitable for inflating the air bag 14. For example, the inflator 36 may contain a stored quantity of pressurized inflation fluid (not shown) in the form of a gas for inflating the air bag 14. The inflator 36 alternatively could contain a combination of pressurized inflation fluid and ignitable material for heating the inflation fluid, or could be a pyrotechnic inflator that uses the combustion of gas-generating material to generate inflation fluid. As a further alternative, the inflator 36 could be of any suitable type or construction for supplying a medium for inflating the air bag 14.

The vehicle 12 includes one or more sensors (shown schematically at 100 in FIG. 1) for sensing the occurrence of an event for which inflation of the air bag 14 is desired. Examples of such events may include a vehicle impact (e.g., front, rear, side, offset, or angled impacts), a vehicle rollover, or both. Upon sensing the event, the sensor 100 provides electrical signal(s) over lead wires 102 to the inflator 36, which causes the inflator to be actuated in a known manner and discharge fluid under pressure into the air bag 14.

The air bag 14 inflates under the pressure of the inflation fluid from the inflator 36. The air bag 14 inflates from the deflated and stored position in the steering wheel 32 to the deployed position between the steering wheel and an occupant 104 of the front vehicle seat 106. The air bag 14, when inflated, thus may help protect a vehicle occupant in the event of an impact to the vehicle 12, a vehicle rollover, or both. The air bag 14, when inflated, helps absorb the energy of impacts with the air bag and helps to distribute the impact energy over a large area of the air bag.

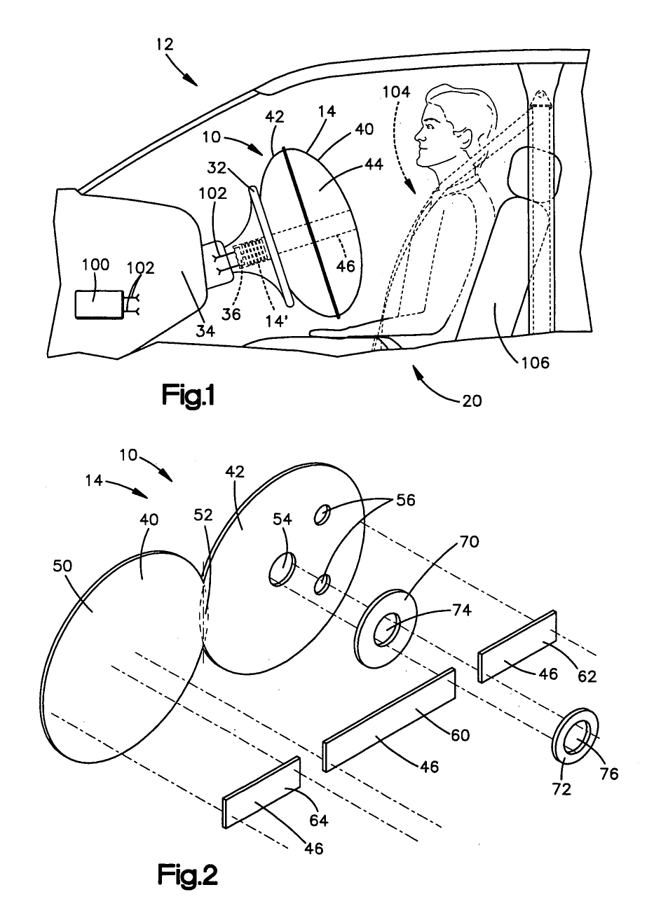

Referring to FIG. 2, the front panel 40 and rear panel 42 of the air bag 14 are formed as a single sheet 50 of material. For example, the sheet 50 may be a woven sheet constructed, for example, with nylon 6-6 yarns. The sheet 50 may be untreated or treated with a coating, laminate, or other suitable material to give the panels 40 and 42 a desired degree of gas permeability.

The front and rear panels 40 and 42 may have any desired shape. For the illustrated driver front impact air bag 14, each of the front and rear panels 40 and 42 has a substantially circular configuration. The panels 40 and 42 merge together at a central region 52 of the sheet 50 delineated by dashed lines in FIG. 2. Thus, by “substantially circular,” it is meant that the panels 40 and 42 are circular with the exception of the central region 52 of the sheet 50 where the panels merge.

The rear panel 42 includes an inflator opening 54 and may also include one or more vent openings 56. In the embodiment of FIG. 2, the tethers 46 include a long tether 60, a first short tether 62, and a second short tether 64. The air bag 14 may also include a heat shield panel 70, a reinforcing panel 72, or both. In the illustrated embodiment, the heat shield panel 70 and reinforcing panel 72 comprise generally ring-shaped sheets of material. The heat shield and reinforcing panels 70 and 72 could, however, have alternative configurations. The heat shield panel 70 and reinforcing panel 72 may be constructed of any desired material. For example, the heat shield panel 70 and reinforcing panel 72 may be constructed of the same material used to construct the front and rear panels 40 and 42, e.g., woven nylon 6-6.

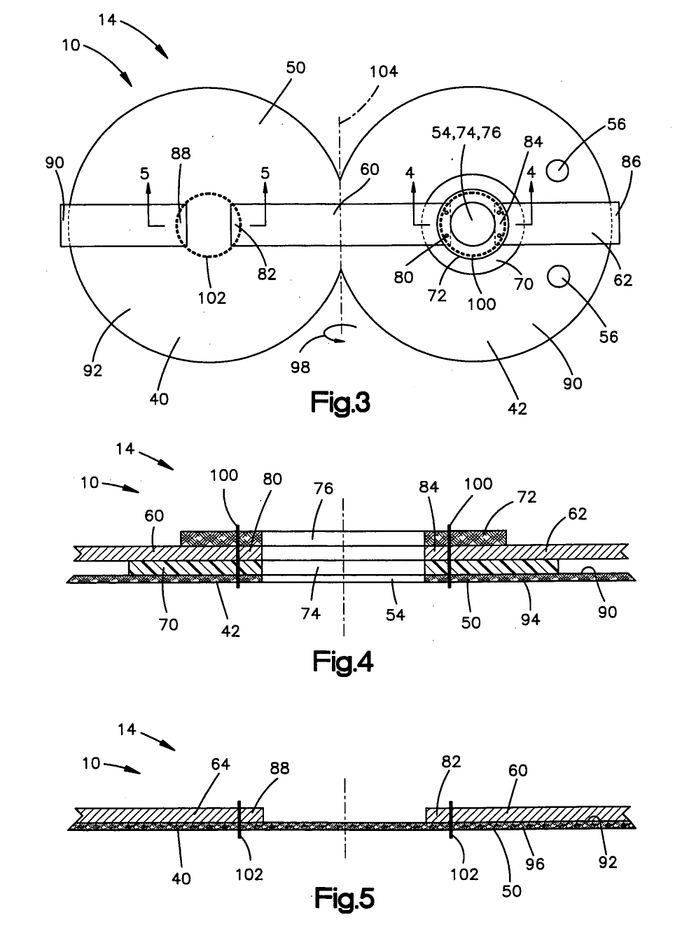

To assemble the air bag 14, the tethers 46 and panels 70 and 72 are moved relative to one another along the dot-dash lines shown in FIG. 2 to overlying positions shown in FIGS. 3 and 4. Referring to FIGS. 3 and 4, the heat shield panel 70 is positioned overlying an upper surface 90 of the rear panel 42 such that a central opening 74 of the heat shield is concentric with the inflator opening 54. A portion of the long tether 60 and the first short tether 62 are positioned overlying the heat shield panel 70 and the front panel 40. A first end portion 80 of the long tether 60 and a first end portion 84 of the first short tether 62 are positioned adjacent the openings 54 and 74. The reinforcing panel 72 is positioned overlying the tethers 60 and 62, the heat shield panel 70, and rear panel 42 such that a central opening 76 of the reinforcing panel is concentric with the heat shield opening 74 and the inflator opening 54.

The air bag 14 includes a first connection 100 that interconnects the rear panel 42, heat shield 70, long tether 60, first short tether 62, and reinforcing panel 72. In the illustrated embodiment, the first connection 100 comprises stitching. The first connection 100 could, however, be formed in an alternative manner, such as by ultrasonic welding, heat bonding, or adhesives. The first connection 100 follows a generally circular pattern concentric with the inflator opening 54, heat shield opening 74, and reinforcing panels opening 76. The first connection 100 could, however, have an alternative pattern.

Referring to FIGS. 3 and 5, a portion of the long tether 60 and the second short tether 64 are positioned overlying an upper surface 92 of the front panel 40. A second end portion 82 of the long tether 60 and a first end portion 88 of the second short tether 64 are positioned spaced from each other near the center of the front panel 40.

The air bag 14 includes a second connection 102 that interconnects the front panel 40, long tether 60, and second short tether 64. In the illustrated embodiment, the second connection 102 comprises stitching. The second connection 102 could, however, be formed in an alternative manner, such as by ultrasonic welding, heat bonding, or adhesives. The second connection 102 follows a generally circular pattern. The second connection 102 could, however, have an alternative pattern.

As shown in FIG. 3, the air bag 14 may also include fastener openings 80 for receiving fasteners for connecting the air bag to the vehicle 12. The fastener openings 80 may be formed in an operation performed after the first and second connections 100 and 102 are formed as described above. For example, the fastener openings 80 may be formed via die cutting. This method may also be used to form the inflator opening 54 and vent openings 56 in the rear panel 42, the opening 74 in the heat shield panel 70, and the opening 76 in the reinforcing panel 72.

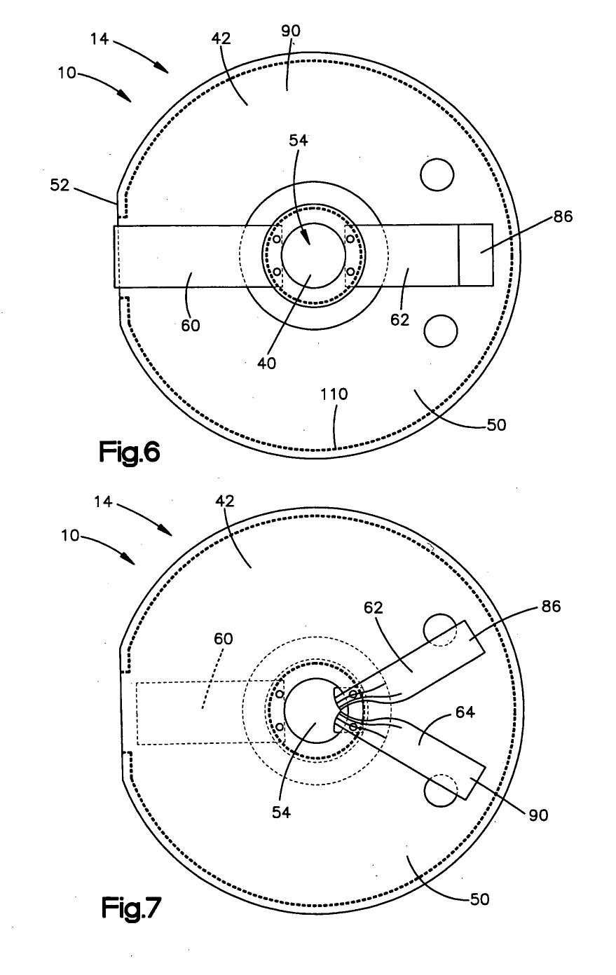

Once the air bag 14 is in the condition shown in FIGS. 3, 4, and 5, the sheet 50 folded over along the fold line indicated generally at 104 in FIG. 3. This positions the front and rear panels 40 and 42 adjacent and overlying each other. More particularly, the sheet 50 is folded in the direction of the arrow indicated generally at 98 such that a lower surface 94 (see FIG. 4) of the rear panel 42 is positioned adjacent to and overlying a lower surface 96 (see FIG. 5) of the front panel 40. FIG. 6 illustrates the air bag 14 with the sheet 50 folded such that the rear panel 42 overlies the front panel 40.

Referring to FIG. 6, while the front and rear panels 40 and 42 are positioned overlying each other with the upper surfaces 90 and 92 facing outward, a perimeter connection 110 is formed to interconnect the panels. The perimeter connection 110 extends along the perimeter of the panels 40 and 42 and thus has a generally circular configuration, with the exception of the straight portion shown in the central region 52. The perimeter connection 110 could, however, have an alternative pattern. In the illustrated embodiment, the perimeter connection 110 comprises stitching. The perimeter connection 110 could, however, be formed in an alternative manner, such as by ultrasonic welding, heat bonding, or adhesives. The second end 86 of the first short tether 62 and the second end of the second short tether (not shown in FIG. 6) may be folded over to avoid connection via the perimeter connection 110.

The upper surfaces 90 and 92 of the front and rear panels 40 and 42 form inside wall surfaces of the air bag 14. When the air bag 14 is in the condition shown in FIG. 6, however, the upper surfaces 90 and 92 form outside wall surfaces, i.e., the air bag 14 is inside-out. To make the upper surfaces 90 and 92 form inside surfaces of the air bag 14, the front panel 40 is drawn through the inflator opening 54 in the rear panel 42. This places the air bag 14 in the condition of FIG. 7.

Referring to FIG. 7, when the upper surfaces 90 and 92 of the front and rear panels 40 and 42 form inside surfaces of the air bag 14, the long tether 60, the first and second short tethers 62 and 64, the heat shield panel 70, and the reinforcing panel 72 are positioned inside the air bag, i.e., within the inflatable volume 44 of the air bag. As shown in FIG. 7, the first and second short tethers 62 and 64 are drawn through the inflator opening 54 placing their respective second end portions 86 and 90 outside the air bag 14.

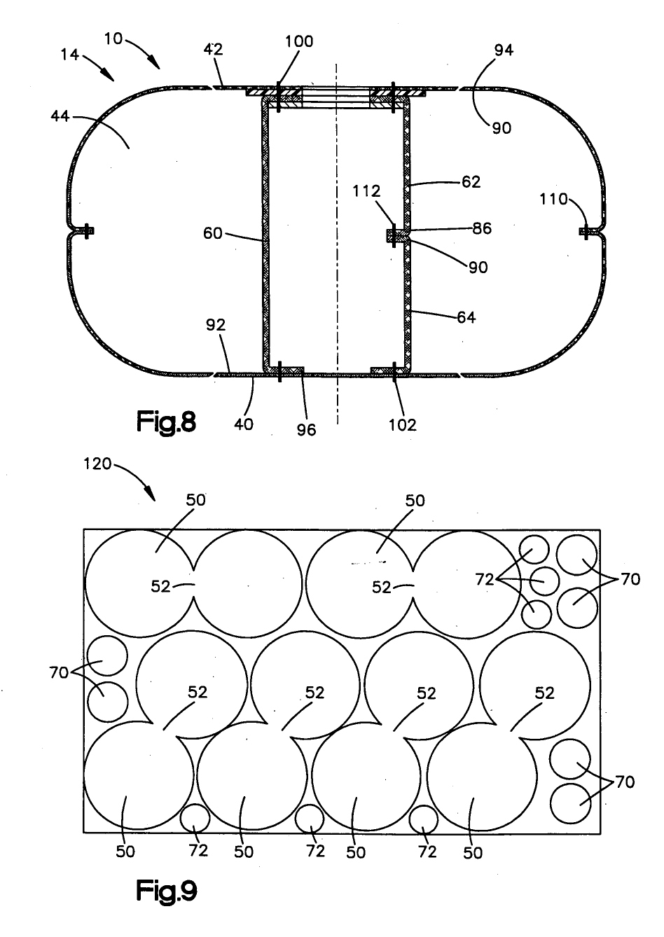

While the short tethers 62 and 64 are positioned outside the air bag 14, their second end portions 86 and 90 are placed overlying each other. The second end portions 86 and 90 are interconnected by a third connection 112, which is best shown in FIG. 8. The first and second short tethers 62 and 64, connected to each other, are then placed within the inflatable volume 44 of the air bag 14, as shown in FIG. 8. In the illustrated embodiment, the third connection 112 comprises stitching. The third connection 112 could, however, be formed in an alternative manner, such as by ultrasonic welding, heat bonding, or adhesives. When the air bag 14 is assembled as shown in FIG. 8, the long tether 60 and the connected short tethers 62 and 64 help control the distance between the front and rear panels 40 and 42, which helps determine the inflated depth or thickness of the air bag.

Referring to FIG. 9, the sheet 50 that forms the front and rear panels 40 and 42 is cut from a larger, bulk sheet 120 of material. FIG. 9 illustrates a portion of the bulk sheet 120 that includes the material required to cut the sheets 50, heat shield panels 70, and reinforcing panels 72 for six air bags. As shown in FIG. 9, these panels are cut to leave little waste material from the bulk sheet 120. This is facilitated by the single piece construction of the front and rear panels and, more specifically, the shared material in the central regions 52 of the sheets 50.

In one particular example, the air bag has a diameter of 685 millimeters. For this air bag, the front panels, rear panels, heat shield panels, and reinforcing panels are cut from a bulk sheet having a width of 2145 millimeters. In a construction of the air bag where the front and rear panels are separate, the front, rear, heat shield, and reinforcing panels for five air bags can be cut from a length of 3182.5 millimeters of the bulk sheet. Using the construction disclosed herein where the front and rear panels are formed from a single sheet, the front, rear, heat shield, and reinforcing panels for six air bags can be cut from a length of 3312.5 millimeters of the bulk sheet. In this example, the air bag construction of the present invention realized material savings of about 13.3%.

The construction of the air bag 14 of the present invention also helps reduce or minimize the manufacturing steps required to produce the bag. As set forth above, the rear panel 42 (see FIG. 3), heat shield panel 70, long tether 60, first short tether 62, and reinforcing panel 72 are interconnected via the single first connection 100, which may be a single stitch line. The front panel 40, the long tether 60, and the second short tether 64 are interconnected via the single second connection 102, which may also be a single stitch line. The front and rear panels 40 and 42 are interconnected via the single perimeter connection 110, which may also be a single stitch line. The first and second short tethers 62 and 64 are interconnected via the single third connection 112, which may also be a single stitch line. This construction may also help reduce the number of sewing stations required to assemble the air bag 14.

From the above description of the invention, those skilled in the art will perceive improvements, changes and modifications. Such improvements, changes and modifications within the skill of the art are intended to be covered by the appended claims.

Having described the invention, the following is claimed:

1. An inflatable vehicle occupant protection device comprising:
a single sheet of material comprising a front panel and a rear panel each having a substantially circular configuration, the sheet having a central portion where peripheral portions of the front and rear panels merge with each other;
the sheet being folded along the central portion to position the front and rear panels overlying each other; and
a perimeter connection that connects the front and rear panels along a periphery of the front and rear panels to form an inflatable volume of the inflatable vehicle occupant protection device.

2. The protection device recited in claim 1, further comprising:
a long tether for interconnecting the front and rear panels;
first and second short tethers for interconnecting the front and rear panels;
a first connection that connects a first end of the long tether and a first end of the first short tether to the rear panel;
a second connection that connects a second end of the long tether and a first end of the second short tether to the front panel;
a third connection that connects second ends of the first and second short tethers.

3. The protection device recited in claim 2, wherein the protection device is free from any other connections for interconnecting any of the panels and tethers.

4. The protection device recited in claim 2, wherein the first and second short tethers when interconnected have a combined length about equal to the length of the long tether.

5. The protection device recited in claim 2, wherein the rear panel includes an inflator opening, the protection device further comprising a heat shield panel encircling the inflator opening, the heat shield panel being connected to the rear panel by the first connection.

6. The protection device recited in claim 5, wherein multiple sheets are cut from a bulk sheet of material in a nested pattern, multiple heat shield panels being cut from portions of the bulk sheet apart from the nested sheets.

7. The protection device recited in claim 5, further comprising a reinforcing panel encircling the inflator opening, the reinforcing panel being connected to the rear panel by the first connection.

8. The protection device recited in claim 7, wherein multiple sheets are cut from a bulk sheet of material in a nested pattern, multiple heat shield panels and multiple reinforcing panels being cut from portions of the bulk sheet apart from the nested sheets.

9. The protection device recited in claim 2, wherein the rear panel includes an inflator opening, the protection device further comprising a reinforcing panel encircling the inflator opening, the reinforcing panel being connected to the rear panel by the first connection.

10. The protection device recited in claim 9, wherein multiple sheets are cut from a bulk sheet of material in a nested pattern, multiple reinforcing panels being cut from portions of the bulk sheet apart from the nested sheets.

11. The protection device recited in claim 2, wherein the second ends of the first and second short tethers are adapted to extend through the inflator opening for interconnection with each other outside the protection device.

12. The protection device recited in claim 2, wherein the first, second, third, and perimeter connections comprise stitching.

13. An inflatable vehicle occupant protection device comprising:
a single sheet of material comprising a front panel and a rear panel, the sheet being folded over to position the front and rear panels overlying each other;
a long tether for interconnecting the front and rear panels;
first and second short tethers for interconnecting the front and rear panels;
a first connection that connects a first end of the long tether and a first end of the first short tether to the rear panel;
a second connection that connects a second end of the long tether and a first end of the second short tether to the front panel;
a third connection that connects second ends of the first and second short tethers; and
a perimeter connection that connects the front and rear panels along a periphery of the front and rear panels to form an inflatable volume of the inflatable vehicle occupant protection device.

14. An inflatable vehicle occupant protection device comprising:
a sheet of material comprising a front panel and a rear panel, the sheet being one of a plurality of sheets cut from a bulk sheet of material in a nested pattern; and
at least one of a heat shield panel and a reinforcing panel, the at least one of a heat shield panel and a reinforcing panel being cut from a portion of the bulk sheet of material left over from the nested pattern of sheets.
